(19) United States
(12) Patent Application Publication
(10) Pub. No.: US 2020/0271274 A1
(43) Pub. Date: Aug. 27, 2020

(54) TEMPORARY GAS STORAGE SYSTEM

(71) Applicant: CECO ENVIRONMENTAL IP INC., Dallas, TX (US)

(72) Inventors: David TAYLOR, Plano, TX (US); Timothy Todd SHIPPY, Frisco, TX (US)

(21) Appl. No.: 16/286,395

(22) Filed: Feb. 26, 2019

(51) Int. Cl. F17C 5/02; F17C 5/06; F17C 7/02

(52) U.S. Cl. CPC F17C 5/02; F17C 5/06; F17C 7/02; F17C 2227/0157; F17C 2205/0352; F17C 2205/0323; F17C 2225/0153; F17C 2221/033; F17C 2270/0121; F17C 2270/0105; F17C 2223/0123; F17C 2225/0123; F17C 2225/036

(57) ABSTRACT

A storage system for temporary storage of a gas comprising a storage vessel configured to store a pressurized gas or liquid; at least one of a compressor configured to pressurize the gas and provide the pressurized fluid or a liquefaction apparatus operable to liquefy the gas to provide the liquid; and piping associated with one or more valves, wherein the piping and the associated one or more valves are configured to provide: (a) in a first configuration, inflow of the gas into the compressor or the liquefaction apparatus, wherein the compressor is configured to pressurize the inflowing gas to provide the pressurized fluid or wherein the liquefaction apparatus is configured to liquefy the inflowing gas to provide the liquid, and introduce the pressurized gas or the liquid into the temporary storage vessel; and (b) in a second configuration, outflow of the pressurized gas or liquid from the temporary storage vessel.

### TECHNICAL FIELD

The present disclosure relates to systems and methods for temporary storage of gas; more specifically, this disclosure relates to systems and methods for temporarily storing gas, rather than venting or flaring the gas; still more specifically, the present disclosure relates to systems and methods for removing gas from a gas enclosure, reducing the volume of the gas to provide a fluid (e.g., a gas or a liquid) having a reduced volume, temporarily storing the reduced volume fluid in a temporary storage vessel, and reintroducing the gas into the or another gas enclosure.

### BACKGROUND

Situations arise in which a gas must be removed from a gas enclosure or source, such as equipment, a well, or a pipeline. For example, a pipeline or well may need maintenance or a workover, for which the presence of a gas (e.g., a pressurized gas) therein is undesirable. In such instances, the nature of the gas may make venting or flaring of the gas into the atmosphere undesirable (e.g., a toxic gas or a greenhouse gas (GHG)). It may be desirable to temporarily store such gas in order to reduce dangers to the environment and/or to reduce cost (e.g., emissions penalties and loss of the value of the gas when flared or vented rather than being sold or processed into a product for sale).

As an example, during the production of natural gas, there are instances in which it is conventional practice to vent the flow of gas directly to the atmosphere. This procedure is known as blowing down. When a system is blown down, a large volume of gas and liquid escapes directly into the atmosphere, becoming a source of significant pollution. Among others, one situation in which it is standard procedure to blow down a natural gas production system is when the pressure in a well has decreased to a pressure below that on a service or distribution line due to an accumulation of liquid in a pipe string that brings the gas to the well head.

Likewise, a gas line utilized to convey gas from a well to a service line for public use is sometimes blown down in order to repair and maintain the lines. Under normal conditions, the lines are blown down to atmospheric pressure, with the contents of the pressurized portion which is to be serviced being vented directly to the atmosphere. Such blowdown also results in a substantial amount of pollution.

Venting of such gas and liquid to the atmosphere can result in a considerable loss of a non-renewable resource, can cause damage to the environment (e.g., when the gas is a GHG), and/or can result in increased costs due to the need for emissions permits and associated paperwork and/or a reduction in an amount of the gas or a product produced therefrom that is ultimately available to be sold at a profit. Accordingly, there is a need for systems and methods of temporarily storing gas whereby the gas is not introduced into the atmosphere via venting or flaring and a value of the gas may be realized.

### BRIEF SUMMARY

Disclosed herein is a storage system for temporary storage of a gas, the system comprising: a temporary storage vessel configured to store a pressurized gas or a liquid; at least one of a compressor configured to pressurize the gas and provide the pressurized fluid, or a liquefaction apparatus operable to liquefy the gas to provide the liquid; and piping associated with one or more valves, wherein the piping and the associated one or more valves are configured to provide: (a) in a first configuration, inflow of the gas into the compressor or the liquefaction apparatus, wherein the compressor is configured to pressurize the inflowing gas to provide the pressurized fluid or wherein the liquefaction apparatus is configured to liquefy the inflowing gas to provide the liquid, and introduce the pressurized gas or the liquid into the temporary storage vessel; and (b) in a second configuration, outflow of the pressurized gas or the liquid from the temporary storage vessel.

Also disclosed herein is a method of temporarily storing a trapped gas, the method comprising: pressurizing at least a portion of the trapped gas in a first storage vessel from a first pressure, at which the gas is trapped, to a second pressure via a compressor to provide a pressurized. gas or liquefying at least a portion of the trapped gas via liquefaction apparatus to provide a liquid at the second pressure; introducing the pressurized gas or the liquid into a temporary storage vessel; temporarily storing the pressurized gas or the liquid in the temporary storage vessel; and performing a workover on the first storage vessel after pressurizing the trapped gas.

### BRIEF DESCRIPTION OF THE DRAWINGS

For a detailed description of aspects of the disclosed methods, reference will now be made to the accompanying drawing in which:

FIG. 1 is a schematic of a temporary gas storage system I, according to an embodiment of this disclosure, integrated with a gas source or enclosure 40; and

FIG. 2 is a schematic of a temporary gas storage system IA, according to another embodiment of this disclosure, integrated with a gas source or enclosure 40′.

### DETAILED DESCRIPTION

Disclosed herein are systems and methods for the temporary storage of gas to help reduce emissions to the environment. As an example, during the production of natural gas, there are instances in which it is conventional practice to vent the flow of gas directly to the atmosphere. This procedure is known as blowing down. When a system is blown down, a large volume of gas and liquid escapes directly into the atmosphere, becoming a source of pollution. Among others, one situation in which it is standard procedure to blow down a natural gas production system is when the pressure in a well has decreased to a pressure below that on a service or distribution line due to an accumulation of liquid in a pipe string that brings the gas to the well head. Likewise, a gas line utilized to convey gas from a well to a service line for public use is sometimes blown down in order to repair and maintain the lines. Under normal conditions, the lines are blown down to atmospheric pressure or below, with the contents of the pressurized portion which is to be serviced being vented directly to the atmosphere. Such blowdown also results in a release of gasses contributing to pollution.

Venting of such gas and liquid to the atmosphere can result in a considerable loss of a non-renewable resource, can cause damage to the environment (e.g., when the gas is a GHG), and/or can result in increased costs due to the need for emissions permits and associated paperwork and/or a reduction in an amount of the gas or a product produced therefrom that is ultimately available to be sold at a profit. Accordingly, it would be useful to have systems and methods for temporarily storing gas whereby the gas is not released into the atmosphere via venting or flaring and a value of the gas may be realized.

Disclosed herein are systems and methods of temporarily storing a gas. Although referred to at times herein as temporary ‘gas’ storage systems and methods, it is to be understood that the gas to be temporarily stored can be stored as a fluid (e.g., in gaseous and/or liquid form) according to this disclosure. The herein disclosed systems and methods can be utilized, in some embodiments, for temporarily storing a gas that is conventionally vented or flared, prior to introduction of the gas back into a gas enclosure from which it was initially captured for temporary storage or introduction (e.g., in gaseous or liquid form) into another enclosure. In this manner, an amount of the gas flared or vented to the atmosphere can be reduced or eliminated. Reducing an amount of the gas vented or flared can enhance economics, for example, by reducing emissions permitting costs in some applications and/or increasing an amount of the gas (or a product produced therefrom) available for later sale, and/or can concomitantly reduce or substantially eliminate a negative environmental impact resulting from production of the gas.

Although described hereinbelow with reference to natural gas and methane, the herein disclosed system and method can be utilized for temporary storage of other gases, regardless of whether or not the gases are conventionally flared or vented or whether or not the gases are greenhouse gases. In embodiments, the herein disclosed temporary gas storage system and method can be utilized for the management of any type of gas. The temporary gas storage system and method may be particularly suited for the temporary storage of a compressible gas or vapor that has value that can be realized by temporarily storing the gas rather than disposing of it by venting or flaring.

In embodiments, herein disclosed are a system and method for temporarily storing natural gas. Such systems and methods can enable a reduction or elimination of air pollution caused by the direct venting of such gas (e.g., from wells, natural gas transmission lines, etc.) to the atmosphere, and reduce or substantially eliminate a direct and unnecessary waste of natural gas resources.

The systems and methods herein can be used to evacuate a gas in a first storage vessel such as a section of isolated pipeline, a compressor, surface piping, flow lines, and the like. Unlike situations in which a gas is taken off of a pipeline, the process of evacuating the gas from the first storage vessel can begin at the initial pressure of the gas in the first storage vessel, and the pressure can then drop as the gas is transferred out of the first storage vessel. A compressor or other motive device can then be used to extract the gas from the first storage vessel and transfer it to a temporary storage vessel. In order to perform work on the first storage vessel, it may be useful to remove as much of the gas as possible.

Once the work is complete, the gas can either be moved back into the first storage vessel and/or transferred for another use elsewhere. Wherever the gas is used, a compressor or other motive device may be used to transfer the gas out of the temporary storage vessel. Since both the inflow and outflow of the temporary storage vessel may rely on a compressor to move the gas between vessels or containers, a single compressor may be used with associated piping and valves to enable the same compressor to move the gas into and out of the temporary storage vessel. In some embodiments, the gas may be used to fuel the compressor or motive device, thereby providing a system that can be portable while enabling the temporary storage and compression/recompression of gas.

### Temporary Gas Storage System

Herein disclosed are a storage system and method for temporary storage of a gas. In embodiments, the system comprises a temporary storage vessel operable to store a fluid (e.g., a liquid or a gas), a volume reduction apparatus operable to produce, from the gas, a fluid having a volume less than that of the gas introduced thereto (e.g., a compressor operable to pressurize the gas to provide a fluid comprising a pressurized gas to be temporarily stored, a refrigeration apparatus operable to cool the gas to provide a fluid comprising a cooled gas to be temporarily stored, or a liquefaction apparatus operable to liquefy the gas to provide a fluid comprising a liquid to be temporarily stored), and piping associated with one or more valves. The piping and the associated valves can be operable to provide two-way fluid flow including: (a) in a first configuration, inflow of the gas into the volume reduction apparatus, where the inflowing gas is converted to the fluid having the reduced volume relative to the gas introduced into the volume reduction apparatus, and introduction of the fluid into the temporary storage vessel, and (b) in a second configuration, outflow of the fluid from the temporary storage vessel.

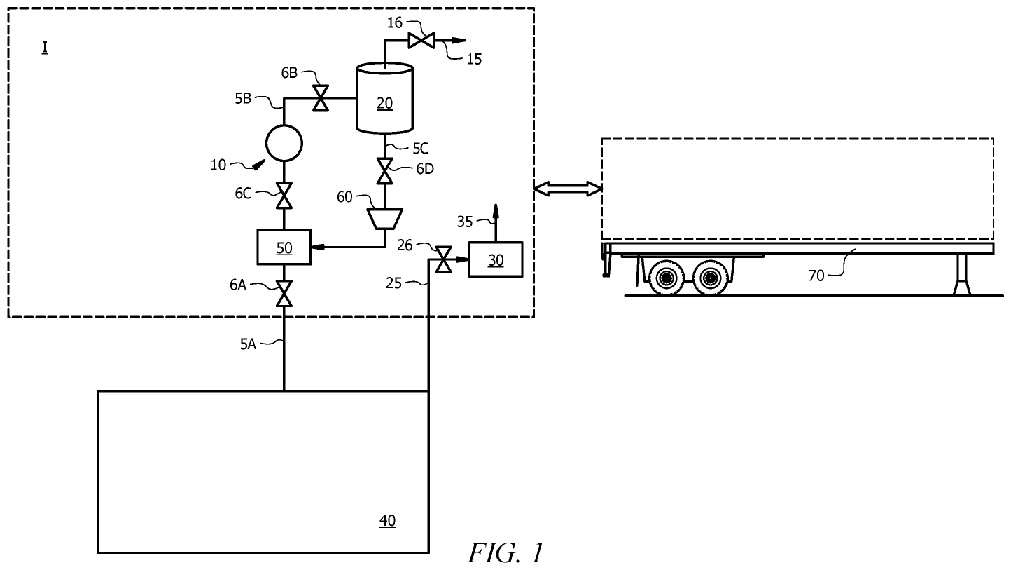

With reference to FIG. 1, which is a schematic of a temporary storage system I for temporarily storing a gas, a temporary storage system I of this disclosure can comprise a motive device or pump 10 fluidly connected via piping 5 with a temporary storage vessel (also referred to herein as an ‘intermediate storage vessel’) 20. The piping 5 can be configured to provide: (a) in a first configuration, inflow of the gas into the motive device 10, and subsequently into the temporary storage vessel 20, and (b) in a second configuration, outflow of the stored fluid from the temporary storage vessel 20. The system thereby allows the gas or fluid contained in the equipment to be serviced to be stored for later use.

In some embodiments, the motive device 10 can comprise a volume reduction apparatus such as a compressor, liquefaction unit, and the like where the inflowing gas can be converted to a fluid having a volume that is less than, and in some embodiments, substantially less than, that of the gas as received, and introduction of the fluid into the temporary storage vessel 20. A reduced volume of the gas may allow for a mobile system to be used to store a larger volume of gas while the equipment is being serviced. However, a reduced volume may not be needed in all situations, and the disclosure of an optional volume reduction apparatus is not needed in all embodiments.

In some embodiments, the motive device 10 can be any apparatus suitable for converting the gas introduced thereto into a fluid having a volume less than that of the volume of gas that is to be temporarily stored. The volume reduction apparatus 10 can reduce a volume of the gas via increasing the pressure, reducing the temperature thereof, and/or using volume reduction techniques (e.g., use of storage materials, hydrates, etc.). For example, the volume reduction apparatus 10 can, in some embodiments, be operable to increase a pressure of the gas to provide a pressurized gas having a volume V2 less than a volume V1 of the gas as received. In such embodiments, for example, volume reduction apparatus 10 can comprise one or more compressors. Alternatively or additionally, volume reduction apparatus 10 can, in some embodiments, be operable to decrease a temperature of the gas to provide a chilled fluid (e.g., a gas or a liquid) having a volume V2 less than a volume V1 of the gas as received. In such embodiments, for example, volume reduction apparatus 10 can comprise refrigeration apparatus operable to cool the gas to provide a cooled gas, liquefaction apparatus operable to liquefy the gas to provide a liquid, or the like, as known in the art. Other techniques including the use of materials in which a gas is soluble can also be used. Suitable compressors, refrigeration units, and liquefaction apparatus are known to those of skill in the art with the aid of this disclosure.

In embodiments, the system can be configured to allow the motive device 10 to be used for both inflowing and outflowing gas. For example, a piping and valving system can be used to fluidly couple the inlet to the motive device 10 to the original or first storage vessel, and the outlet of the motive device 10 to the inlet of the temporary storage vessel when the gas is being moved into the temporary storage vessel. When the gas is being moved out of the temporary storage vessel, the piping and associated valving can be reconfigured to fluidly couple the outlet of the temporary storage vessel to the inlet of the motive device 10, and the outlet of the motive device 10 to a fluid conduit coupled to the subsequent gas storage location (e.g., the original or first storage vessel, a different storage vessel, a sales pipeline, a compressed natural gas sales location, etc.). In this fashion, the motive device 10 can be considered reversible based on the ability to change the flow path using the piping and valving configurations.

The volume V2 of the volume reduced fluid introduced into the temporary storage vessel 20 would generally be less than or equal to a volume V2′ of the temporary storage vessel in order to use a single vessel. In some embodiments, a plurality of temporary storage vessels in one or more groups (e.g., on one or more portable units) can be fluidly coupled to provide a temporary storage volume larger than that of any one temporary storage vessel. The volume V2′ of the temporary storage vessel 20 or vessels (and the volume V3 of the separator 30, when utilized, as further described hereinbelow) can be selected to be sufficient to handle the volume V1 of the gas from the gas source or enclosure 40 that is to be temporarily stored. In some embodiments, the volume V1 of the gas from the gas source or enclosure 40 that is to be temporarily stored can be from about 1.1 to about 600, from about 2 to about 150, or from about 5 to about 50 times larger than the volume V2′ of the temporary storage vessel 20 or vessels. By enabling such a reduction in volume, a temporary storage system and method of this disclosure can be operable to provide temporary storage of gas from large gas source, such as (e.g., up to at least 5, 10, 20, or 30) miles of gas pipeline, in embodiments.

The temporary storage vessel 20 or vessels can have any suitable size and shape. For example, in embodiments, the gas can be stored as a pressurized gas, and the temporary storage vessel can be substantially spherical or cylindrical. In embodiments, the temporary storage vessel 20 or vessels can comprise a gas tank. In embodiments, the temporary storage vessel 20 or vessels can comprise an inflatable storage vessel and/or an inflatable bladder inside of a larger pressure vessel. In some embodiments, the temporary storage vessel 20 or vessels an comprise a cylindrical or spherical pressure vessel or tank. The gas can be liquefied for storage in the temporary storage vessel 20, and the temporary storage vessel 20 may not be a pressure vessel (e.g., is configured for storage of liquefied gas at or about atmospheric pressure). In some embodiments, the liquefied gas can be stored in a temporary storage vessel 20 comprising one or more interconnecting pipes. In some embodiments, a temporary storage system or method of this disclosure employs a plurality of storage vessels such as described above. For example, in some embodiments, a temporary storage system of this disclosure comprises at least 1, 2, 3, 4, 5, or more temporary storage vessels 20. In some embodiments, temporary storage vessel 20 may be operable to store a fluid at a pressure of at least 1,000 psia, 2,000 psia, 3,000 psia, 4,000 psia, or 4,750 psia.

The temporary storage system of this disclosure comprises piping 5 (e.g., piping sections 5A, 5B, 5C of FIG. 1) and associated valves (e.g., valves 6A, 6B, 6C of FIG. 1) operable to connect temporary storage system I with a source of the gas to be temporarily stored, indicated as gas source or enclosure 40 in the embodiment of FIG. 1. The piping and the associated valves are operable to provide two-way fluid flow including: (a) in a first configuration, inflow of the gas to be temporarily stored into the motive device 10 (e.g., into a compressor, a chiller, or a liquefaction apparatus), whereby the inflowing gas can be introduction of the fluid having the reduced volume into temporary storage vessel 20; and (b) in a second configuration, outflow of the stored fluid (e.g., the pressurized and/or cooled gas, or the liquid) from temporary storage vessel 20. In some embodiments, the inflowing gas can be converted to a fluid having a reduced volume V2 relative to a volume V1 of the gas to be stored (e.g., is pressurized in a compressor to provide a pressurized gas, cooled in a chiller to provide a cooled gas, or liquefied in the liquefaction apparatus to provide a liquid). The piping 5 thus comprises one or more piping sections for the introduction and/or removal of material from temporary storage system I. For example, temporary storage system I can include a piping section (e.g., piping section 5A in the embodiment of FIG. 1) operable to introduce the gas to be stored from an external gas source or enclosure 40 into temporary storage system I. The same or another piping section may be operable for the removal of material (e.g., the fluid as stored in temporary storage vessel 20 or subsequent pressure and/or temperature adjustment in apparatus 60 and/or component separation/removal in additional apparatus 50, described further hereinbelow). The one or more piping sections for the introduction and/or removal of material from the temporary storage system can be flexible and/or quick connect hoses, for example, to facilitate introduction of gas from external gas source or enclosure 40 and removal of material (e.g., gas or liquid) from the temporary storage system I.

In some embodiments, the inflow of the gas from the gas source or enclosure 40 of the gas to be temporarily stored to the temporary storage vessel 20 is provided by substantially the same piping utilized for the outflow of the stored fluid from the temporary storage vessel out of temporary storage system I. For example, the motive device 10 can comprise a compressor, and the piping (e.g., piping sections 5A and 5B) and valves (e.g., valves 6A, 6B, and/or 6C) are operable to provide a) in the first configuration, inflow of the gas into the motive device 10 (for example via valves 6A and/or 6C and piping section 5A), and introduction (e.g., via valve 6B and piping section 5B) of the pressurized gas having the reduced volume V2 into the temporary storage vessel 20, and (b) in the second configuration, outflow of the pressurized gas from temporary storage vessel 20 (e.g., via valve 6B and piping section 5B) through the same motive device 10 and/or bypass piping, and reintroduction into gas enclosure or source 40 or introduction into another gas enclosure (e.g., via valves 6A and/or 6B and piping section 5A). In some embodiments, the inflowing gas can be converted to a pressurized gas having a reduced volume V2 relative to a volume V1 of the gas introduced into the compressor volume reduction apparatus 10. In some embodiments, the same motive device 10 can be employed to return the stored pressurized gas to the gas source or enclosure 40, following the temporary storage in temporary storage vessel 20.

Alternatively or additionally, piping 5 may provide an alternate flow path for the gas and/or liquid inflow relative to the stored fluid outflow from temporary storage vessel 20. For example, as indicated in the embodiment of FIG. 1, piping section 5C and valve 6D may provide an outflow path for stored fluid that is disparate from the inflow path (e.g., provided by valves 6A, 6B and/or 6C and piping sections 5A and 5B).

In some embodiments, the temporary storage system comprises at least one valve (e.g., valve 6B) positioned on the piping 5 (e.g., on piping section 5B) between the motive device 10 and the temporary storage vessel 20. The temporary storage system comprises least one valve (e.g., valve 5A and/or valve 5B) positioned on the piping 5 (e.g., on piping section 5A) between the volume reduction apparatus 10 and an end of the piping distal the temporary storage vessel 20 (e.g., on one or more piping sections configured for the introduction and/or removal of material from temporary storage system I).

In some embodiments, after storing the fluid (e.g., the pressurized and/or cooled gas or the liquid) in temporary storage vessel 20, the stored fluid may be returned to the gas source from which it was extracted. For example, when the gas is being temporarily stored for maintenance of a gas enclosure from which the gas was extracted for temporary storage, the stored fluid may be reintroduced into the gas enclosure (e.g., in gaseous form). Alternatively or additionally, a portion of the stored fluid may be transported elsewhere. The stored fluid may be returned to its initial state (e.g., heated, pressure reduced, and/or regasified) prior to reintroduction into the gas enclosure or elsewhere. In some embodiments, the stored fluid can be removed from temporary storage vessel 20 by utilizing a motive device 10 to return the pressurized gas to the gas source, or by reducing a pressure and/or increasing a temperature of the stored pressurized gas or the liquid by pressure and/or temperature adjustment apparatus 60, described further hereinbelow, and introducing the resulting gas to gas enclosure or source 40 or another gas enclosure. For example, in some embodiments, the motive device 10 can comprise cooling and/or liquefaction apparatus, and the temporary storage vessel can be employed for storage of the cooled and/or liquefied gas. In such embodiments, a pressure and/or temperature adjustment apparatus 60 may comprise a heater or vaporizer configured to reheat and/or regasify the stored fluid by heating. In other embodiments, the motive device 10 can comprise a compression volume reduction apparatus, and the temporary storage vessel 20 can be employed for storage of a pressurized gas produced therein. In such embodiments, pressure and/or temperature adjustment apparatus 60 may comprise a pressure reduction apparatus configured to reduce a pressure of the stored pressurized gas (e.g., by expansion). Although indicated on piping section 5C in the embodiment of FIG. 1, it is to be understood that pressure and/or temperature adjustment apparatus 60 may be located elsewhere within temporary storage system I, for example, on piping section 5B.

The gas source or gas enclosure 40 from which the gas to be stored is introduced into the temporary gas storage system of this disclosure can comprise any isolated gas (also referred to herein as ‘trapped’ gas) for which temporary storage is desired. For example the trapped gas can be introduced into the temporary storage system from a pipeline, a compressor station, a natural gas pipeline pig launching and/or receiving station, a power plant, a boiler, a heat recovery steam generator (HRSG), an industrial plant, a chemical plant, a refinery, an offshore platform, a shipboard system, or a combination thereof. As will be apparent to those of skill in the art, other sources of isolated or trapped gas are possible, and the present systems and methods can be used to store such other sources of trapped gas. Within these systems, one or more isolation valves can be used to isolate or trap the gas, thus creating the trapped gas transferred to the temporary storage.

In some embodiments, the temporary storage system can further comprise additional apparatus within the system, As shown FIG. 1, such additional apparatus 50 can include an inlet filtration system that can comprise a filtration unit, a separation unit, a silencer, or any combination thereof, operable to subject a fluid flowing therethrough to filtration, separation (e.g., gas/liquid separation), and/or to silence the operation of the system, respectively. In some embodiments, the inlet filtration system 50 can be positioned at any suitable location within temporary storage system I. In embodiments, temporary storage system I can comprises a filtration unit, a separation unit, or both for removing one or more components from the inflowing gas and/or from an outflowing fluid (e.g., an outflowing gas). For example, when gas enclosure 40 comprises a gas pipeline, it may be desirable to remove one or more components from the gas prior to introduction into volume reduction apparatus 10 (e.g., a compressor, cooling, or liquefaction apparatus). For example, when the motive device 10 comprises a liquefaction apparatus, the inlet filtration system 50 can comprise a separation apparatus for the removal of water, acid gases, heavy hydrocarbons, and the like from the incoming gas prior to liquefaction. When the motive device 10 comprises a compression apparatus, the inlet filtration system 50 can comprise separation apparatus for the removal of liquids from the incoming gas prior to introduction into the one or more compressors. Likewise, piping 5 may be configured for outflow via the inlet filtration system 50, where the flow can be in the same direction as the inlet flow, or a separate filtration system can be used for the outgoing flow. For example, following outflow through pressure and/or temperature adjustment apparatus 60, the resulting heated and/or depressurized fluid (which may now be primarily gaseous) may be passed through filtration and/or separation in additional apparatus 50, for example, to remove any residual liquids therefrom.

The herein disclosed temporary storage system I can, in some embodiments, further comprise a line 15 and a pressure relief valve 16 fluidly connected with the temporary storage vessel 20 and operable to release fluid (e.g., gas) from temporary storage vessel 20, in the event of an over-pressure situation.

The herein disclosed temporary storage system I can, in some embodiments, further comprise a block valve vent separator comprising a valve 26 and a separator 30 operable to prevent over pressurization of the original storage unit. For example, in situations in which the stored gas is replaced into the original vessel or volume, the motive device 10 may be used to pass the gas back into the original volume, and in some embodiments, the gas may be compressed to a desired pressure. In the event that this process results in a pressure above a threshold for the original volume, the valve 26 may be used to help protect the original volume from potential failure due to the increased pressure. Piping 25 may be configured to introduce a final amount of gas from the gas source or enclosure 40 to separator 30 via valve 26, and vent line 35 may introduce an amount of separated gas from separator 30 to atmosphere. Separator 30 may have a volume V3. Volume V3 will be a small volume fraction (e.g., less than 5, 4, 3, 2, or 1 volume percent) of the volume V1 of gas from gas source or enclosure 40 that is to be temporarily stored. Separator 30 may be used to catch any liquids in the gas or any liquids that form as part of a pressure release event.

### Mobile or Permanent Design

The temporary storage system of this disclosure can be configured as a permanent unit, or as a temporary unit, which in some embodiments can be designed to be transportable. As understood by those of skill in the art, it is generally not possible to predict where on a pipeline a maintenance operation will be required. Consequently, it is contemplated that the temporary storage system of the present disclosure can be configured as a mobile unit. The mobile unit can be of a portable nature so as to be readily transported to a site at which the gas to be temporarily stored is located and to a site (which may be the same or a different site from the site at which the gas to be temporarily stored is located) from which the temporarily stored gas swill be offloaded from the temporary storage system. Accordingly, in embodiments, temporary storage system I further comprises a mobile platform, such as, without limitation, a trailer 70, configured for transport of the temporary gas storage system over land, a boat, configured for transport of the temporary storage system over water, or a plane, configured for transport of the temporary storage system. As noted hereinabove, one or more inlet and/or outlet lines of the temporary storage system can comprise quick-connect couplings and flexible couplings whereby gas can be introduced into and removed from a mobile temporary storage system.

### Temporary Gas Storage Method

In embodiments, a method of temporarily storing a trapped gas according to this disclosure comprises: (a) introducing the fluid (e.g., a pressurized and/or chilled gas or a liquid) into a temporary storage vessel; and (b) temporarily storing the fluid in the temporary storage vessel. In some embodiments, at least a portion, a majority (e.g., greater than or equal to about 90, 91, 92, 93, 94, 95, 96, 97, 99, or 99.5 volume percent), or substantially all of the trapped gas can be converted into a fluid having a volume that is less than a volume of the at least a portion, the majority, or the substantially all of the trapped gas at initial conditions (e.g., temperature and pressure as trapped in gas source or enclosure 40). In some embodiments, the trapped gas can be pressurized from a first pressure, at which the gas is trapped, to a second pressure via a compressor to provide a pressurized gas, and/or at least a portion of the trapped gas can be liquefied via a liquefaction apparatus to provide the fluid a liquid. In some embodiments, a minor portion of the trapped gas (e.g., less than about 5, 4, 3, 2, or 1 volume percent) of the trapped gas can be intentionally vented and/or flared. For example, a portion may be vented and/or flared via a block valve vent separator 26/30 in order to flush or purge the initial storage volume to avoid the presence of an explosive mixture prior to a workover. The trapped gas can be any gas noted hereinabove.

When the gas is subject to a volume reduction as part of the process, the volume reduction can be effected via any volume reducing apparatus described hereinabove or known in the art. For example, the volume reduction apparatus can comprise one or more compressors, chillers/refrigerators, or liquefaction apparatus. The temporary storage vessel can be a temporary storage vessel as described hereinabove. Introducing gas to be stored from the gas enclosure to the volume reduction apparatus and the resulting fluid from the volume reduction apparatus into the temporary storage vessel can be effected via piping associated with one or more valves, as described hereinabove, wherein the piping and the associated one or more valves are operable to provide two-way fluid flow including: (a) in a first configuration, inflow of the at least a portion, the majority, or the substantially all of the trapped gas into the volume reduction apparatus, whereby the inflowing gas is converted to the fluid (e.g., is pressurized in one or more compressors to provide as the fluid a pressurized gas, chilled in one or more chillers to provide as the fluid a chilled gas, or liquefied in a liquefaction apparatus to provide as the fluid a liquid), and introduction of the fluid (e.g., the pressurized gas, the chilled gas or the liquid) into the temporary storage vessel; and (b) in a second configuration, outflow of the stored fluid from the temporary storage vessel.

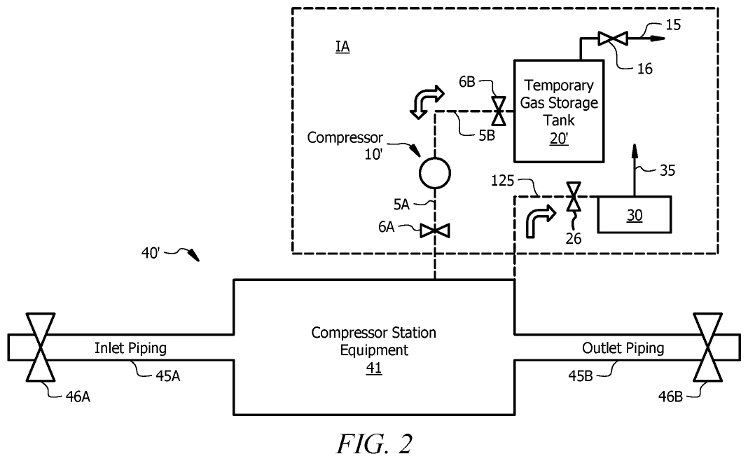

In some embodiments, the temporary storage method of this disclosure can further comprise removing the fluid (e.g., the pressurized gas, the chilled gas, or the liquid) from the temporary storage vessel 20. In some embodiments, as described in more detail hereinbelow with regard to FIG. 2, at least a portion of the trapped gas can be pressurized from the first pressure to the second pressure via one or more compressors to provide a pressurized gas. In some embodiments, removing the pressurized gas from the temporary storage vessel can be effected via flow from the increased pressure to the decreased pressure of the final storage volume. As the pressure is reduced, the same compressor used to pressurize the gas can be used to compress the gas from the temporary storage vessel to drive the gas into the final storage volume.

A temporarily stored fluid can be depressurized, heated, and/or regasified via pressure and/or temperature adjustment apparatus 60 during removal from the temporary storage vessel 20, as described hereinabove, to provide an effluent gas for reintroduction into the gas enclosure from which the trapped gas was initially introduced into the temporary storage system or introduction into another gas enclosure disparate from the gas enclosure from which the trapped gas was initially introduced into the temporary gas storage system.

In some embodiments, the effluent gas can be introduced into a compressor station from which the trapped gas was originally extracted for introduction into the temporary gas storage system, introduced as a fuel gas for one or more compressors of a compressor station from which the trapped gas was originally extracted for introduction into the temporary gas storage system, introduced as fuel for the motive device 10, and/or introduced into another gas enclosure at the same or a different site from a site at which the trapped gas was originally introduced into the temporary storage system.

### System and Method for the Temporary Storage of Natural Gas via Compression Thereof

Although, as noted hereinabove, a temporary storage system and method of this disclosure can be utilized to store a variety of gases from a plethora of gas sources or enclosures and via a variety of volume reducing apparatus, a description of a temporary natural gas storage system operable to temporarily store natural gas via compression thereof will now be described in more detail. It is, however, to be noted that the storage of other gases from other gas sources or enclosures and via other volume reducing apparatus is intended to be covered by this disclosure.

Description of an exemplary gas storage system will now be made with reference to FIG. 2, which is a schematic of a temporary storage system IA, according to embodiments of this disclosure, integrated with a gas source or enclosure 40′ comprising a section of a compressor station.

When maintenance is needed at a natural gas compressor station, the gas must be removed from a portion of the compressor station piping prior to commencing servicing. Currently, the industry standard for removing natural gas from pipeline compressor stations is via direct venting to the atmosphere or via flaring. For example, before any equipment is opened for servicing, the station is isolated from the main pipeline (e.g., via closure of main station block valves 46A and 46B of the embodiment of FIG. 2) and the gas removed from the isolated compressor station piping and equipment prior to maintenance thereof. During this process, raw methane gas is conventionally released to the atmosphere, resulting in negative environmental impacts. In addition, this quantity of vented or flared gas is no longer available to be transported through the pipeline for use as fuel or sale. By blowing off the gas, the natural gas escapes into the atmosphere unused. Natural gas emissions are generally undesirable because methane, the primary component of natural gas, is a powerful greenhouse gases. Furthermore, the blowdown of natural gas incurs a concomitant safety risk because buildings, personnel, or facilities are often located nearby or directly on-site. The pumping of gas out of an isolated section can reduce natural gas emissions, but the installation of a pumping station to evacuate an isolated line can incur considerable costs, which make the pumping of smaller amounts of gas uneconomical.

The herein disclosed temporary storage system and method allow the volume of gas that is contained in a gas enclosure, such as an isolated section of compressor station, to be relocated into a temporary storage vessel (e.g., a gas storage tank) while the gas enclosure the section of the compressor station) is isolated (e.g., from a main pipeline) so that work can be performed on the gas enclosure.

Temporary storage system IA comprises at least one compressor 10′, at least one gas storage tank 20′, and piping 5 (e including piping sections 5A and 5B) associated with one or more valves (e.g., valves 6A and 6B), wherein the piping and the associated one or more valves are operable to provide two-way fluid flow including: (a) in a first configuration, inflow of the gas from gas source or enclosure 40′ intro compressor 10′, wherein the inflowing gas is pressurized in the compressor to provide a pressurized gas, and introduction of the pressurized gas into the gas storage tank 20′; and (b) in a second configuration, outflow of the pressurized gas from the gas storage tank 20′.

With reference to FIG. 2, gas source or gas enclosure 40′ comprises an isolated section of a compressor station. Main pipeline station block valves 46A and 46B are closed to isolate a portion of the compressor station for maintenance or some other purpose. The gas to be temporarily stored by temporary storage system IA of this disclosure is initially contained in the isolated section or gas enclosure 40′ comprising inlet piping 45A, compressor station equipment 41, and outlet piping 45B and has an ‘as received’ gas volume V1 (e.g., at the temperature and pressure of the isolated section).

Temporary gas storage tank 20′ can be designed to have smaller than a volume V1 of the gas in the isolated compressor station/piping. Accordingly, in some embodiments, one or more compressors 10′ can be used to drive the gas from the volume V1 of the isolated or trapped gas to a reduced volume V2 of pressurized gas, wherein volume V2 is less than volume V2′ of the at least one gas storage tank 20′. After the workover is performed at the gas enclosure (e.g., the isolated section of the compressor station), the gas can be reintroduced thereto (e.g., into the main pipeline). Alternatively or additionally, the stored gas can be used as fuel gas on- or off-site, for example, to a sales location and/or to support the re-start of one or more compressors of the compressor station equipment 41. Alternatively or additionally, the stored gas can be used on-site for another purpose or transported elsewhere on-site or to an off-site location. The stored gas can, in embodiments, be returned to initial conditions (e.g., reduced in pressure back to the initial pressure of the gas in the gas enclosure, and thus returned to as-received volume V1) prior to removal from the temporary storage system.

Isolated gas from gas source or gas enclosure 40″ can be introduced into one or more compressors 10′ of temporary gas storage system IA via piping section 5A and valve 6A. In embodiments, the one or more compressors can be used to pressurize the pas from the first pressure (e.g., at which the gas is isolated, trapped, or received) to a second pressure to provide a pressurized gas. In embodiments, the first pressure is a pressure in a range of from about 100 to about 2,000 psi, or from about 500 to about 1,500 psi. In embodiments, the second pressure is a pressure in a range of from about 500 to about 4,700 psi, from about 600 to about 4,000 psi, or from about 750 to about 3,000 psi. In some embodiments, the second pressure may be approximately the same as the first pressure and other conditions such as temperature can be modified (e.g., reduced) to increase the volume of gas stored. After initial transfer of gas from gas enclosure 40′ to gas storage tank 20′, a final small amount of gas may, in embodiments, be removed from gas enclosure 40′ via block vent valve separator 30, which can be fluidly connected with gas enclosure 40′ via a line 25.

As noted hereinabove with reference to the embodiment of FIG. 1, the gas from gas enclosure 40′ can, in some embodiments, be introduced into an inlet filter system 50. For example, in some embodiments, gas from gas enclosure 40′ can be introduced into an inlet filter system 50 configured for the removal of one or more components therefrom. In embodiments, additional apparatus 50 is configured for the removal of liquids from the gas prior to introduction via piping section 5A and optionally valve 6C into the one or more compressors 10′.

The pressurized gas can be introduced from the one or more compressors 10′ to temporary gas storage vessel 20′, in which the pressurized gas is stored for a time. The pressurized gas may be stored for any desired length of time, for example, from 5 minutes to six months, from an hour to three months, or from a day to a week. In some embodiments, the trapped or isolated gas can have a first volume V1 at the first pressure (at which it is found in gas enclosure 40′). The one or more compressors 10′ may be operable to provide a sufficient pressure to reduce the volume of the gas from volume V1 to a volume V2 where the ratio of V1:V2 is at least 2:1, 3:1, 4:1, 5:1, 6:1, 7:1, 8:1, 9:1, 10:1, 20:1, 30:1, 40:1, or 50:1, herein volume V2 is less than or equal to a volume V2′ of gas storage tank(s) 20′. In some embodiments, the gas can be liquefied, which can result in volume ratios of V1:V1 of greater than 300:1, 400:1 or 500:1.

In some embodiments, gas storage tank(s) 20′ is a storage tank as described hereinabove, including any of those described with respect to FIG. 1. For example, gas storage tank(s) 20′ can comprise one or more spherical pressure vessels, cylindrical pressure vessels, or pipe segments.

As described hereinabove with reference to the embodiment of FIG. 1, safety may be enhanced via utilization of a pressure relief valve 16 and pressure relief line 15 fluidly connected with gas storage tank(s) 20′.

The temporary gas storage system IA may be configured as a mobile or permanent unit, as noted hereinabove with reference to the embodiment of FIG. 1. In some embodiments, following temporary storage, the gas can be reintroduced into the same gas enclosure 40′ from which it was introduced into temporary storage system IA. Alternatively, the stored pressurized gas can, in embodiments, be introduced into a disparate gas enclosure, such as a downstream section of piping, a fuel line for a compressor of the compressor station, or another gas enclosure located a distance away from the gas enclosure 40′ from which the gas was initially extracted for introduction into temporary gas storage system IA. In the latter embodiment, the temporary storage system can be configured as a mobile unit, and the temporary gas storage system may be moved to the disparate gas enclosure location by land, air, and/or sea. Accordingly, the gas may be introduced into the temporary gas storage system of this disclosure at a first site and removed from the temporary gas storage system at a second site disparate from (e.g., a distance away) the first site. The second site can be located separate from the first site, such as miles or more away. For example, the second site can be a sales location located remotely from the first site.

Regardless of the location of the gas enclosure into which the stored gas can be introduced following temporary storage thereof in temporary storage system IA, following temporary storage of the pressurized gas, temporary storage system IA may be reconnected with the original or another gas enclosure, for example via inlet piping section 5A, which may be a quick connect or flexible hose, as described hereinabove. In embodiments, following repair, servicing, or other maintenance, modification, or workover of the gas source or gas enclosure 40′, the stored gas can be reintroduced thereto. The pressurized gas may be reintroduced into gas enclosure 40′ or another gas enclosure by reversing the flow of the gas relative to the flow utilized to introduce the gas from the gas enclosure 40′ to the one or more compressors 10′ and the at least one temporary gas storage tank 20′. For example, in embodiments, the pressurized gas can be returned to gas enclosure 40′ or introduced into another gas enclosure by passage through piping section 5B and valve 6B, compressor(s) 10′, and piping section 5A and valve 6A. That is, in some embodiments, the one or more compressors 10′ can be used to both pull the gas into the temporary storage system IA as well as remove it from the temporary storage system IA following temporary storage therein. Other piping and valving arrangements are possible, such as a system with only one of valves 6A or 6B, or outflow of pressurized gas via a disparate piping section, such as a piping section 5C, as indicated in the embodiment of FIG. 1.

The pressurized gas may be de-pressurized during outflow from temporary storage gas tank(s) 20′ back to gas enclosure 40′ or another gas enclosure. For example, as depicted in the embodiment of FIG. 1, pressurized gas may, in embodiments, be passed through a pressure reduction apparatus 60 to decrease the pressure thereof prior to passage out of temporary storage system IA.

### Features and Potential Advantages

The herein disclosed temporary storage system and method can provide one or more of the following advantages: (i) improved public perception of (e.g., pipeline operating) companies, which may simplify and expedite an approval process for new projects, (ii) maintaining availability of the gas (e.g., natural gas) for use as fuel, reactant, or for sale, (iii) elimination of the need for venting and/or flaring and associated capital equipment to manage the processes which produce the gas safely and per applicable regulations, (iv) reduction or elimination of emissions (or intentional emissions) of undesirable gases (e.g., toxic gases and/or greenhouse gases, such as methane gas) to the atmosphere, which emissions may present negative environmental effects, and (v) a reduced amount of regulatory paperwork and associated expenses for process operators (e.g., pipeline and compressor station operators). In embodiments, substantially none or less than 10, 9, 8, 7, 6, 5, 4, 3, 2, or 1 vol % of the total volume of the trapped gas may be intentionally vented or flared, or be unintentionally lost to the atmosphere when utilizing a temporary storage system and method of this disclosure to temporarily store a gas when a gas enclosure in which the gas is initially isolated is opened for servicing or the like. For example, in some embodiments, substantially none or less than 10, 9, 8, 5, 4, 3, 2, or 1 vol % of the total volume of the isolated or trapped gas is intentionally vented or flared, or is unintentionally lost to the atmosphere during a workover of a well or compression station via utilization of the herein disclosed temporary storage system and method. Additional advantages of the temporary storage systems and methods as disclosed herein can be apparent to one of skill in the art viewing this disclosure.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the systems and methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. § 1.72 and the purpose stated in 37 C.F.R. § 1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### Additional Disclosure

The particular embodiments disclosed above are illustrative only, as the present disclosure ma be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and such variations are considered within the scope and spirit of the present disclosure, Alternative embodiments that result from combining, integrating, and/or omitting features of the embodiment(s) are also within the scope of the disclosure. While compositions and methods are described in broader terms of “having”, “comprising,” “containing,” or “including” various components or steps, the compositions and methods can also “consist essentially of” or “consist of” the various components and steps. Use of the term “optionally” with respect to any element of a claim means that the element is required, or alternatively, the element is not required, both alternatives being within the scope of the claim.

Numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Embodiments disclosed herein include:

A: A storage system for temporary storage of a gas, the system comprising: a temporary storage vessel configured to store a pressurized gas or a liquid; at least one of a compressor configured to pressurize the gas and provide the pressurized fluid, or a liquefaction apparatus operable to liquefy the gas to provide the liquid; and piping associated with one or more valves, wherein the piping and the associated one or more valves are configured to provide: (a) in a first configuration, inflow of the gas into the compressor or the liquefaction apparatus, wherein the compressor is configured to pressurize the inflowing gas to provide the pressurized fluid or wherein the liquefaction apparatus is configured to liquefy the inflowing gas to provide the liquid, and introduce the pressurized gas or the liquid into the temporary storage vessel; and (b) in a second configuration, outflow of the pressurized gas or the liquid from the temporary storage vessel.

B: A method of temporarily storing a trapped gas, the method comprising: pressurizing at least a portion of the trapped gas in a first storage vessel from a first pressure, at which the gas is trapped, to a second pressure via a compressor to provide a pressurized gas or liquefying at least a portion of the trapped gas via liquefaction apparatus to provide a liquid at the second pressure; introducing the pressurized gas or the liquid into a temporary storage vessel; temporarily storing the pressurized gas or the liquid in the temporary storage vessel; and performing a workover on the first storage vessel after pressurizing the trapped gas.

Each of embodiments A and B may have one or more of the following additional elements: Element 1: wherein at least one of the one or more valves is positioned on the piping between the compressor or the liquefaction apparatus and the temporary storage vessel. Element 2: wherein at least one of the one or more valves is positioned on the piping between the compressor or the liquefaction apparatus and an end of the piping distal the temporary storage vessel. Element 3: further comprising a block valve vent separator operable to vent a residual gas from a first storage volume, wherein the first storage volume is configured to hold the gas prior to the gas flowing to the compressor or liquefaction apparatus. Element 4: further comprising a pressure relief valve on the temporary storage vessel. Element 5: wherein the temporary storage vessel is substantially spherical or cylindrical. Element 6: wherein the temporary storage vessel is operable to, and the compressor can provide pressurized gas having, a pressure of at least 3,000 psia. Element 7: wherein the storage system is configured as a mobile unit. Element 8: wherein the compressor is configured to pressurize the gas to provide the pressurized gas, and wherein the temporary storage vessel is a pressurized gas storage vessel. Element 9: wherein, in the second configuration, the piping and the one or more valves are configured to direct the outflow of pressurized gas from the temporary storage vessel via the compressor. Element 10: wherein the liquefaction apparatus is configured to liquefy the gas to provide the liquid, wherein the temporary storage vessel is a liquid storage vessel. Element 11: further comprising a filtration unit, a separation unit, a silencer, or a combination thereof, and wherein, in the first configuration, in the second configuration, or both, the inflow, the outflow, or both is via the filtration unit, the separation unit, the silencer, or the combination thereof. Element 12: further comprising the gas disposed within the temporary storage vessel, wherein the gas comprises methane, associated gas, natural gas, or a combination thereof. Element 13: further comprising: venting a second portion of the trapped gas from the first storage vessel. Element 14: further comprising: removing the pressurized gas or the liquid from the temporary storage vessel. Element 15: wherein pressurizing at least the portion of the trapped gas uses a compressor to provide the pressurized gas, and wherein removing the pressurized gas is effected via the compressor. Element 16: wherein removing the pressurized gas or the liquid from the temporary storage vessel are effected via at least one two-way valve. Element 17: wherein the trapped gas is introduced into the compressor or the liquefaction apparatus from a compressor station, a natural gas pipeline pig launching and receiving station, a power plant, a boiler, a heat recovery steam generator (HRSG), an industrial plant, a chemical plant, a refinery, an offshore platform, a shipboard system, or a combination thereof. Element 18: wherein a first volume of the gas at the first pressure is from about 2 to 600 times larger than a second volume of the gas at the second pressure, Element 19: further comprising: extracting the pressurized gas from the temporary storage vessel; and reintroducing it into the compressor station. Element 20: further comprising: extracting the liquid from the temporary storage vessel; regasifying the liquid to provide an extracted gas; and reintroducing the extracted gas into the compressor station. Element 21: further comprising: using at least a portion of the gas as a fuel for the compressor. Element 22: wherein the temporary storage vessel comprises a pressure relief valve. Element 23: wherein less than 10 volume percent (vol %) of a total volume of the trapped gas is vented or flared. Element 24: wherein temporarily storing the pressurized gas is performed on a mobile unit. Element 25: wherein the compressor or the liquefaction apparatus is fluidly connected with the first storage vessel via a flexible flow line.

While certain embodiments have been shown and described, modifications thereof can be made by one skilled in the art without departing from the teachings of this disclosure.

Numerous other modifications, equivalents, and alternatives, will become apparent to those skilled in the art once the above disclosure is fully appreciated. It is intended that the following claims be interpreted to embrace such modifications, equivalents, and alternatives where applicable. Accordingly, the scope of protection is not limited by the description set out above but is only limited by the claims which follow, that scope including equivalents of the subject matter of the claims.

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and such variations are considered within the scope and spirit of the present disclosure. Alternative embodiments that result from combining, integrating, and/or omitting features of the embodiment(s) are also within the scope of the disclosure. While compositions and methods are described in broader terms of “having”, “comprising,” “containing,” or “including” various components or steps, the compositions and methods can also “consist essentially of” or “consist of” the various components and steps. Use of the term “optionally” with respect to any element of a claim means that the element is required, or alternatively, the element is not required, both alternatives being within the scope of the claim.

What is claimed is:

1. A storage system for temporary storage of a gas, the system comprising:
a temporary storage vessel configured to store a pressurized gas or a liquid;
at least one of a compressor configured to pressurize the gas and provide the pressurized fluid, or a liquefaction apparatus operable to liquefy the gas to provide the liquid; and
piping associated with one or more valves, wherein the piping and the associated one or more valves are configured to provide:
(a) in a first configuration, inflow of the gas into the compressor or the liquefaction apparatus, wherein the compressor is configured to pressurize the inflowing gas to provide the pressurized fluid or wherein the liquefaction apparatus is configured to liquefy the inflowing gas to provide the liquid, and introduce the pressurized gas or the liquid into the temporary storage vessel; and
(b) in a second configuration, outflow of the pressurized gas or the liquid from the temporary storage vessel.

2. The storage system of claim 1, wherein at least one of the one or more valves is positioned on the piping between the compressor or the liquefaction apparatus and an end of the piping distal the temporary storage vessel.

3. The storage system of claim 1, further comprising: a block valve vent separator operable to vent a residual gas from a first storage volume, wherein the first storage volume is configured to hold the gas prior to the gas flowing to the compressor or liquefaction apparatus.

4. The storage system of claim 1, wherein the temporary storage vessel is operable to, and the compressor can provide pressurized gas having, a pressure of at least 3,000 psia.

5. The storage system of claim 1, wherein the storage system is configured as a mobile unit.

6. The storage system of claim 1, wherein the compressor is configured to pressurize the gas to provide the pressurized gas, and wherein the temporary storage vessel is a pressurized gas storage vessel.

7. The storage system of claim 6, wherein, in the second configuration, the piping and the one or more valves are configured to direct the outflow of pressurized gas from the temporary storage vessel via the compressor.

8. The storage system of claim 1, wherein the liquefaction apparatus is configured to liquefy the gas to provide the liquid, wherein the temporary storage vessel is a liquid storage vessel.

9. The storage system of claim 1, further comprising: a filtration unit, a separation unit, a silencer, or a combination thereof, and wherein, in the first configuration, in the second configuration, or both, the inflow, the outflow, or both is via the filtration unit, the separation unit, the silencer, or the combination thereof.

10. The storage system of claim 1, further comprising: the gas disposed within the temporary storage vessel, wherein the gas comprises methane, associated gas, natural gas, or a combination thereof.

11. A method of temporarily storing a trapped gas, the method comprising:
pressurizing at least a portion of the trapped gas in a first storage vessel from a first pressure, at which the gas is trapped, to a second pressure via a compressor to provide a pressurized gas or liquefying at least a portion of the trapped gas via liquefaction apparatus to provide a liquid at the second pressure;
introducing the pressurized gas or the liquid into a temporary storage vessel;
temporarily storing the pressurized gas or the liquid in the temporary storage vessel; and
performing a workover on the first storage vessel after pressurizing the trapped gas.

12. The method of claim 11, further comprising: venting a second portion of the trapped gas from the first storage vessel.

13. The method of claim 11, further comprising: removing the pressurized gas or the liquid from the temporary storage vessel.

14. The method of claim 13, wherein pressurizing at least the portion of the trapped gas uses a compressor to provide the pressurized gas, and wherein removing the pressurized gas is effected via the compressor.

15. The method of claim 13, wherein removing the pressurized gas or the liquid from the temporary storage vessel are effected via at least one two-way valve.

16. The method of claim 11, wherein the trapped gas is introduced into the compressor or the liquefaction apparatus from a compressor station, a natural gas pipeline pig launching and receiving station, a power plant, a boiler, a heat recovery steam generator (HRSG), an industrial plant, a chemical plant, a refinery, an offshore platform, a shipboard system, or a combination thereof.

17. The method of claim 11, further comprising:
extracting the pressurized gas from the temporary storage vessel; and
reintroducing it into the compressor station.

18. The method of claim 11, further comprising:
extracting the liquid from the temporary storage vessel;
regasifying the liquid to provide an extracted gas; and
reintroducing the extracted gas into the compressor station.

19. The method of claim 11, further comprising:
using at least a portion of the gas as a fuel for the compressor.

20. The method of claim 11, wherein less than 10 volume percent (vol %) of a total volume of the trapped gas is vented or flared.
